(19) United States
(12) Patent Application Publication
(10) Pub. No.: US 2019/0304265 A1
(43) Pub. Date: Oct. 3, 2019

(54) Wristband With Selectable Indicator Lights And Methods Of Use Of A Wristband

(71) Applicant: Joseph R. Guercio, Chattanooga, TN (US)

(72) Inventor: Joseph R. Guercio, Chattanooga, TN (US)

(21) Appl. No.: 16/367,223

(22) Filed: Mar. 27, 2019

Related U.S. Application Data
(60) Provisional application No. 62/648,658, filed on Mar. 27, 2018.

(51) Int. Cl. G08B 5/36; A44C 5/00; A44C 15/00; B32B 15/08; B32B 15/20; F21V 23/02; F21V 23/04

(52) U.S. Cl. CPC G08B 5/36; A44C 5/0053; A44C 15/0015; B32B 15/08; F21Y 2115/10; F21V 23/02; F21V 23/04; B32B 2437/00; B32B 15/20

(57) ABSTRACT

A method for signaling an indication with a light emitting diode (LED)-equipped flexible wristband. The wristband is adjustably sizable for use with different wearers and includes at least one LED. A housing may be disposed on the wristband comprising a first LED, a second LED, and a battery for energizing the first and second LEDs. The method includes pressing selected portions of the wristband to selectively energize the first and second LEDs. The housing is embedded in the wristband. Pressing a selected first portion of the wristband physically closes a first circuit between the first LED and the battery. Pressing a selected second portion of the wristband physically closes a second circuit between the second LED and the battery. Energizing the first LED signals a first indication. Energizing the second LED signals a second indication.

### CROSS-REFERENCE TO RELATED APPLICATION

This application claims priority to U.S. Provisional Application Ser. No. 62/648,658 titled “Wristband with Selectable Indicator Lights and Method of Use of a Wristband,” filed Mar. 27, 2018, which is incorporated herein by reference.

### BACKGROUND OF THE INVENTION

The present invention is directed to disposable wristbands, and, in particular, to wristbands with selectable indicator lights and to methods of using such wristbands in social interactions.

Disposable, single-use wristbands are manufactured from a variety of materials. While such wristbands may be constructed of paper products or other natural fibers, disposable, but highly durable wristbands are typically constructed of man-made materials, such as the high-density polyethylene (HDPE) fiber materials manufactured by DuPont, from Wilmington, Delaware. Such HDPE fiber constructed wristbands have a fabric or paper-like appearance. Such wristbands are also commonly secured with adhesives, with those adhesives typically formulated as security adhesives that firmly bond to the material of the wristband, such that the act of removing the wristband tears the material of the wristband and generally makes the wristband un-reusable.

Such disposable wristbands are used in a variety of settings. For example, disposable wristbands are used in bars, clubs, medical settings, amusement parks, festivals, and other such venues where some indication is provided through the wearing of particular wristbands. The wristband may contain information related to the wearer of the wristband. For example, a particular wristband may indicate that the wearer is above or below a particular age, such as the legal age for purchasing and consuming alcoholic beverages at a venue where underage patrons may be present, such as a club, bar or festival, or that a patron has been properly admitted to a venue. Alternatively, a wristband can be used to indicate something about anyone that is wearing a particular wristband, such as in medical settings, or to indicate that the wearer has an admission to a concert or festival venue. The wristband may indicate that the wearer has purchased a pass to ride the rides at a local fair or carnival. The wristband may also serve as an indication of an evaluation of the wearer. For example, a particular wristband may indicate that the wearer has passed a swimming test, or that the wearer is above or below a particular age, such as the legal age for purchasing and consuming alcoholic beverages at a venue.

### SUMMARY OF THE INVENTION

The present invention provides for a limited use wristband equipped with a selectable indicator light, such as a single-use, disposable wristband. In one form of the invention a flexible and adjustably sizable wristband includes a light emitting diode (LED) capable of illuminating one or more colors, where the colors are used to provide indications to other individuals. In a particular form of the present invention, a light emitting diode (LED)-equipped wristband includes a housing for housing a pair of LEDs, jointly or alternatively positioned, and a battery. The wristband includes conductive material placed such that a first LED built into the wristband is activated and externally visible by pressing on a selected portion of the wristband that closes a first circuit between the first LED and the battery. A second LED built into the wristband may be activated by pressing on another selected portion of the wristband that closes a second circuit between the second LED and the battery. The housing is configured to house the first and second LEDs such that pressing on a first portion of the housing closes a first circuit between the first LED and the battery, and pressing on a second portion of the housing closes a second circuit between the second LED and the battery. The housing is further configured such that closing one of the circuits opens the other circuit.

In another form of the present invention, an LED-equipped wristband includes a housing configured to house a first LED, a second LED, and a battery. The housing includes a first conductive material that forms a first circuit connected to the first LED and a second conductive material that forms a second circuit connected to the second LED. The housing is further configured such that moving the housing in one direction brings the first circuit into contact with the battery, and moving the housing in an opposite direction brings the second circuit into contact with the battery. When the first circuit is closed, the second circuit is open. When the second circuit is closed, the first circuit is open.

In yet another form of the present invention, an LED-equipped wristband includes a housing configured to house a first LED, a second LED, and a battery. The housing includes a first conductive material that forms a first circuit connected to the first LED and a second conductive material that forms a second circuit connected to the second LED. The housing is further configured such that moving the housing in one direction brings the battery in contact with the first circuit, and moving the housing in an opposite direction brings the battery into contact with the second circuit. When the first circuit is closed, the second circuit is open. When the second circuit is closed, the first circuit is open.

In another form of the present invention, an LED-equipped wristband includes a housing configured to house a first LED, a second LED, a selector, and a battery. The housing includes ink traces that form a circuit connecting the battery to the selector. The selector is configured such that actuating the selector selects one of the first and second LEDs. The selector is further configured such that rotating the selector in one direction selects the first LED and rotating the selector in the other direction selects the second LED. Selecting the first LED connects the first LED to the battery and selecting the second LED connects the second LED to the battery. When the first LED is connected to the battery, the second LED is not connected to the battery. When the second LED is connected to the battery, the first LED is not connected to the battery.

In another form of the present invention, an LED-equipped wristband includes a battery housed between adhesive strips, traces connecting a first and second LED spaced apart, and a connection that when wrapped around the wrist and attached at the point of adhesive strips completes the circuit.

In a method of the present invention, a method for signaling an indication with a light emitting diode (LED)-equipped wristband is disclosed, where the method entails selectively illuminating a light of the wristband by a wearer to signal another individual. A wearer may selectively activate a light of a particular color to visually indicate to others information conveyed by the color, such as to individuals in visual proximity to the wearer. For example, a color may be displayed indicating the wearer's availability for social interaction, where the wearer is located in a venue and the color is displayed to all individuals within the venue. Alternatively, a wearer may activate a light of a particular color to visually indicate to a particular individual or a particular subset of individuals information conveyed by the color. In particular embodiments of the method, a plurality of individuals within a venue are wearers of light emitting diode (LED)-equipped wristbands. In which case, wearer's are able to signal to one another, either as groups or individuals, information conveyed by selected colors displayed by the wristbands. For example, one individual wearer may indicate to another individual wearer interest in social interaction by way of a color display intended for that other individual, where such display is an invitation. The other individual may indicate a receptiveness to social interaction by way of one color, such as an acceptance of the invitation, or decline the invitation by way of another color.

In a particular method of the present invention, a method for signaling an indication with a light emitting diode (LED)-equipped wristband with a housing comprising one or more LEDs, such as a first LED, a second LED, and a battery for energizing the first and second LEDs is disclosed. The method includes selectively illuminating a light of a particular color on a wristband by a wearer to signal another individual, such as by pressing selected portions of the wristband to selectively energize the first and second LEDs. The housing is embedded in the wristband. Pressing a selected first portion of the wristband physically closes a first circuit between the first LED and the battery. Pressing a selected second portion of the wristband physically closes a second circuit between the second LED and the battery. Energizing the first LED signals a first indication. Energizing the second LED signals a second indication.

In a further form of the present invention, the housing may include three LEDs. The three LEDs colored such that a selection of at least two LEDs selects a particular color indication display. In one form of the present invention, the housing may include an RGB LED with an RGB LED controller configured to select a particular color as selected with a selector.

In an aspect of the present invention, the selector switch is a tactile membrane switch. In another aspect of the present invention, the selector switch is a rotary selector switch. In a further aspect of the present invention, the selector switch is a momentary pressure switch. In one aspect of the present invention, the selector switch is a rotary dial. In yet another aspect of the present invention, the selector switch is a grouping of tactile switches or membrane switches.

In an aspect of the present invention, conductive materials may include conductive ink traces and/or conductive wires.

In a further aspect of the present invention, the housing may be attached above or below the wristband. In still a further aspect of the present invention, the LEDs, circuits, battery, and any controller(s) may be arranged in, on, or under the wristband without the use of a housing to house the components, or in the alternative, only partially housed in a housing.

These and other objects, advantages, purposes and features of the present invention will become apparent upon review of the following specification in conjunction with the drawings.

### BRIEF DESCRIPTION OF DRAWINGS

FIG. 1A is a block diagram of an LED-equipped wristband with two LEDs according to an embodiment of the present invention.

FIGS. 1B and 1C are block diagrams of LED-equipped wristbands with single LEDs according to an embodiment of the present invention.

FIGS. 2A, 2B, and 2C are block diagrams of an LED-equipped wristband with a shuttle for sliding a battery into electrical contact with either of a first LED and a second LED according to an embodiment of the present invention.

FIGS. 3A, 3B, and 3C are block diagrams of an LED-equipped wristband with a shuttle for sliding an LED into electrical contact with a battery according to an embodiment of the present invention.

FIG. 4 is a block diagram of an LED-equipped wristband with a rotary selector for selecting an LED according to an embodiment of the present invention.

FIG. 5 is a block diagram of an LED-equipped wristband with a housing for momentarily closing a circuit between an LED and a battery according to an embodiment of the present invention.

FIG. 6 is a block diagram of an LED-equipped wristband with a selectable RGB LED indicator according to an embodiment of the present invention.

FIGS. 7A and 7B are block diagrams of LED-equipped wristbands with further exemplary circuits, and components of the circuits for selectively energizing one or more LEDs.

FIG. 8 represents an embodiment of an LED-equipped wristband in connected form as would be worn by a wearer.

FIG. 9 is an exploded view of the embodiment illustrated in FIG. 8.

FIGS. 10A and 10B are front and back side block diagrams of the embodiment illustrated in FIGS. 8 and 9.

### DETAILED DESCRIPTION

Referring now to the drawings and the illustrative embodiments depicted therein, a light emitting diode (LED)-equipped wristband is presented. The wristband may be a constructed of an HDPE-like material, as discussed herein. Other construction materials and techniques may also be used. Regardless of the materials used to make the wristband, an exemplary wristband will include at least one LED indicator and a battery for energizing the at least one LED indicator. The wristband may further contain a selector for selectively energizing the LED indicator. The selector may be a momentary ON/OFF switch (tactile switches or membrane switches) or push ON/push OFF switches. Such momentary switches close a circuit when a button is momentarily pressed and then reopen the circuit when the button is released. Tactile switches may be implemented as membrane switches which include conductive materials, e.g., conductive ink traces and/or conductive wiring that when pressed together close a circuit (e.g., between a battery or power source and an indicator light or some other load).

Other embodiments may not require a selector, but instead utilize a means for closing a selected circuit between a battery and LED, e.g., pressing together separated circuit portions that may be of conductive materials. A further embodiment may utilize a means for closing a circuit between a battery and LED both by securing the wristband by means of an adhesive patch and by pressing together separated circuit portions that may be of conductive materials. Still other embodiments may utilize a selector for LED color selection with the connection to the battery accomplished by other means for joining together the separated circuit portions. A further embodiment may utilize at least two illuminated membrane switches or other types of illuminated momentary switches, with each switch a different color. Further embodiments may utilize portions of any of these other embodiments to realize a selectable LED indicator-equipped wristband. Optionally, the LED may be an RGB LED with a selector for selecting any desired color for the RGB LED to emit, such that a broad selection of color codes may be realized.

In further embodiments, the housing may be attached above or below the wristband. Optionally, the LEDs, circuits, battery, and any controller(s) may be arranged in, on, or under the wristband without the use of a housing to house the components, or in the alternative, only partially housed in a housing.

In an aspect of the present invention, an exemplary LED-equipped wristband 100 may be worn by the wearer desiring to light up one or more indicator LEDs. The one or more indicator LEDs may be selected for particular colors with the selection of a particular color or pattern of display of a particular color providing a desired indication. For example, illuminating a “green” LED may be used to indicate that the wearer of the wristband is available for social interaction, is extending an invitation for social interaction, or is saying “yes” to someone who has line-of-sight to the green glowing LED. Similarly, illuminating a “red” LED may be used to indicate that the wearer of the wristband is instead indicating that they are not available for social interaction, or are saying “no” to a request for social interaction. Other indications could be implied by the selection of the color of the illuminated LED. For example, illuminating the “green” LED may be used to indicate “interested,” while illuminating the “red” LED may be used to indicate “uninterested.” Other signals and/or indications, or codes for the wearer of such an LED-equipped wristband are also anticipated and possible through the selection of a particular color illumination.

For example, a wearer of an LED-equipped wristband at a social gathering may visually indicate to others an interest or disinterest, to signal yes or no, and to signal other visual indicators as selected by the wearer. Optionally, the wearer of the LED-equipped wristband may direct the visual indicator to a particular person to see by shielding the emitting LED from other's view (e.g., by shielding the emitting LED with their other hand). Other uses of illuminating color indicators on such a single-use wristband are also possible. For example, a selectable color illumination may be used for aiding in the identification of members of different teams of individuals, or for identifying the members of different groups of individuals. Other visual indications are also possible through the selection of different color illuminations.

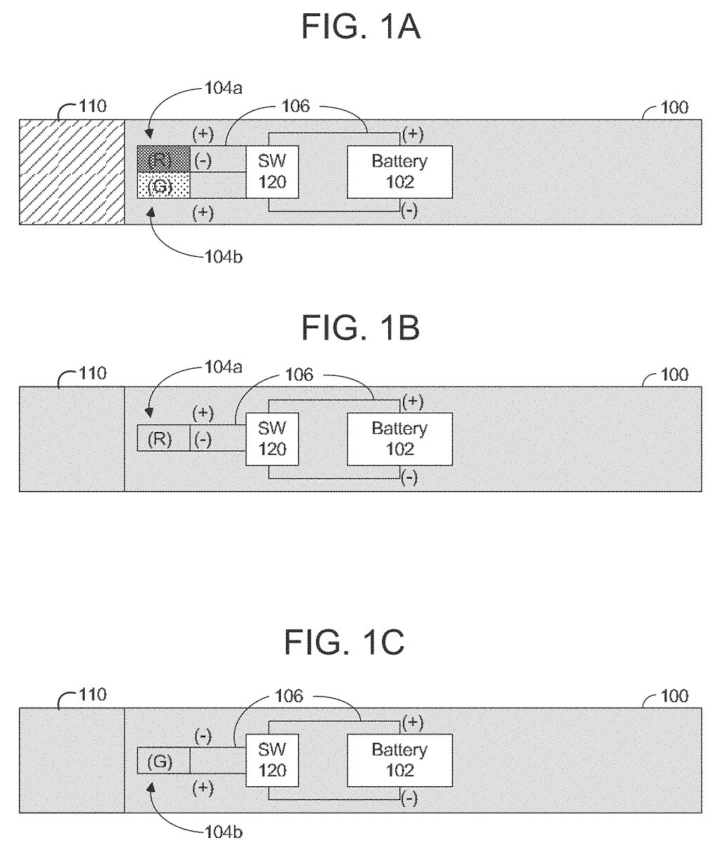

FIG. 1A illustrates an exemplary LED-equipped wristband 100 that includes an adhesive patch 110 for securing the wristband 100. The wristband 100 comprises a flexible material that may be selectively sized and secured to the wrist of a wearer whereby a commonly configured wristband 100 may be used with numerous individuals. The wristband 100 may be patterned with labeling or print indicators that supplement the messaging capabilities of the embedded LEDs, for instance, a corporate brand or event pattern. The adhesive patch 110 may optionally be a security adhesive that bonds to the wristband 100 such that detaching the adhesive patch 110 breaks the wristband material. The wristband 100 further includes a pair of LEDs 104a, 104b. In an aspect of the present invention, the pair of LEDs are a red LED 104a and a green LED 104b. Alternatively, the LED indicators 104a and 104b may emit other contrasting colors. FIGS. 1B and 1C illustrate other embodiments where the wristband 100 includes only a single LED 104, as illustrated in FIGS. 1B and 1C, such that the LED-equipped wristband 100 has only a single-color illumination possibility. As illustrated in FIG. 1A, the wristband 100 includes a battery 102 that is selectively connected to one of the LEDs 104a, 104b. The LED-equipped wristband 100 of FIG. 1A further includes an exemplary switch 120 for selecting either of the LEDs 104a, 104b. The conductive traces 106 from the battery 102 to the switch 120 and from the switch 120 to the LEDs 104a, 104b may be copper wires or in the alternative may be conductive traces formed from conductive ink. Optionally, the switch 120 may be a momentary switch, a push ON-push Off switch, a push ON-momentary ON, or other switch configurations, or other additional means for closing a circuit 106 to the LEDs 104a, 104b.

In an aspect of the present invention, the LEDs 104a, 104b, battery 102, conductive wiring or traces 106, and switch 120 are embedded within the wristband 100 with only a functional portion of the switch 120 exposed. For embodiments that utilize conductive traces or wires 106 that must be physically pressed together to energize a selected LED 104a, 104, icons or text may be imprinted on the wristband 100 to illustrate where a user is to press together the conductive traces or wirings 106. In a further aspect of the present invention, the LEDs 104a, 104b, battery 102, conductive wiring or traces 106, and switch 120 are attached above or below the wristband. As discussed herein, the above components may be arranged in a housing or arranged without the use of a housing.

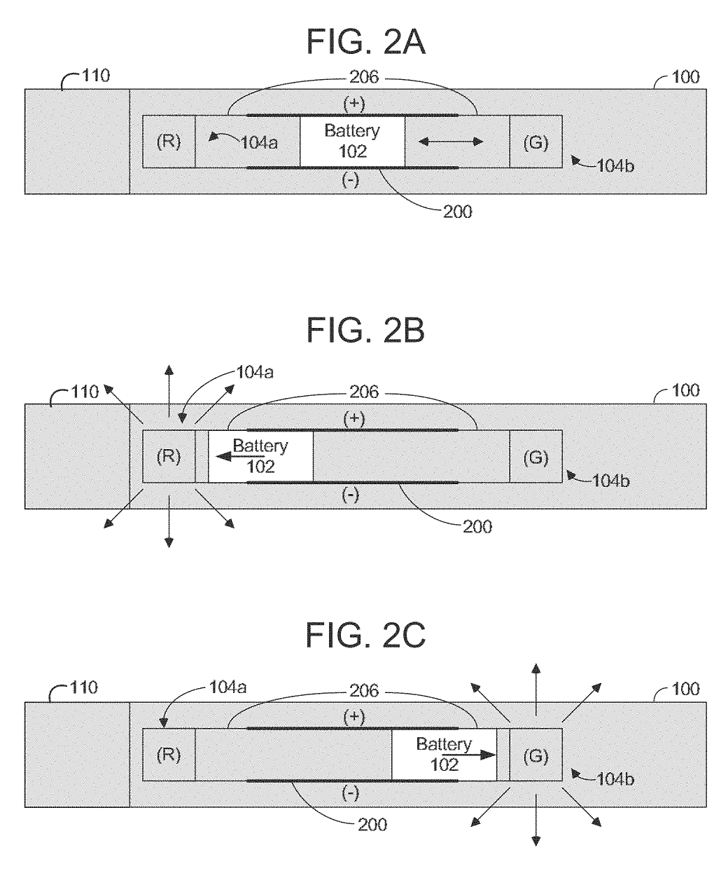

FIG. 2A illustrates another embodiment of an LED-equipped wristband. FIGS. 2B and 2B illustrate an exemplary procedure/operation for selecting which LED 104a, 104b to illuminate. The LED-equipped wristband of FIG. 2A includes an adhesive patch 110 for securely fastening the wristband. The LED-equipped wristband of FIG. 2A includes a housing, carrier, or shuttle 200 that holds two LEDs 104a, 104b in opposing positions, with a battery 102 that freely slides within the housing 200. As illustrated in FIG. 2B, when the battery 102 has been slid far enough towards the left-hand LED (104a), a circuit 206 between the battery 102 and the LED 104a will be closed and the LED 104a will illuminate. Similarly, as illustrated in FIG. 2C, when the battery 102 has been slid far enough towards the right-hand LED (104b), a circuit 206 between the battery 102 and the LED 104b will be closed and the LED 104b will illuminate. As discussed herein, the circuit 206 illustrated in FIGS. 2A, 2B, and 2C may be made from conductive wiring (e.g., copper or silver wiring) or laid down with conductive ink traces, such that the battery 102 is shifted in position to come in contact with the circuit of conductive wiring or traces 206 to illuminate a desired LED (104a, 104b).

In an aspect of the present invention, the LEDs 104, 104b, battery 102, conductive wiring or traces (that make up the circuit 206), and the housing 200 are embedded within the wristband 100 with only a fixture on the battery 102 extending through a slit in the wristband 100 that allows the battery 102 to be shifted along the housing from one LED to the other.

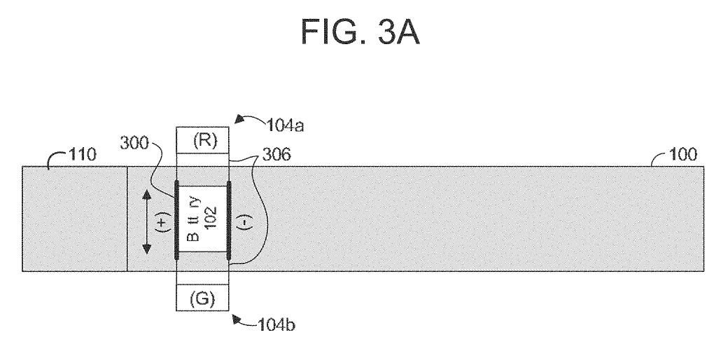

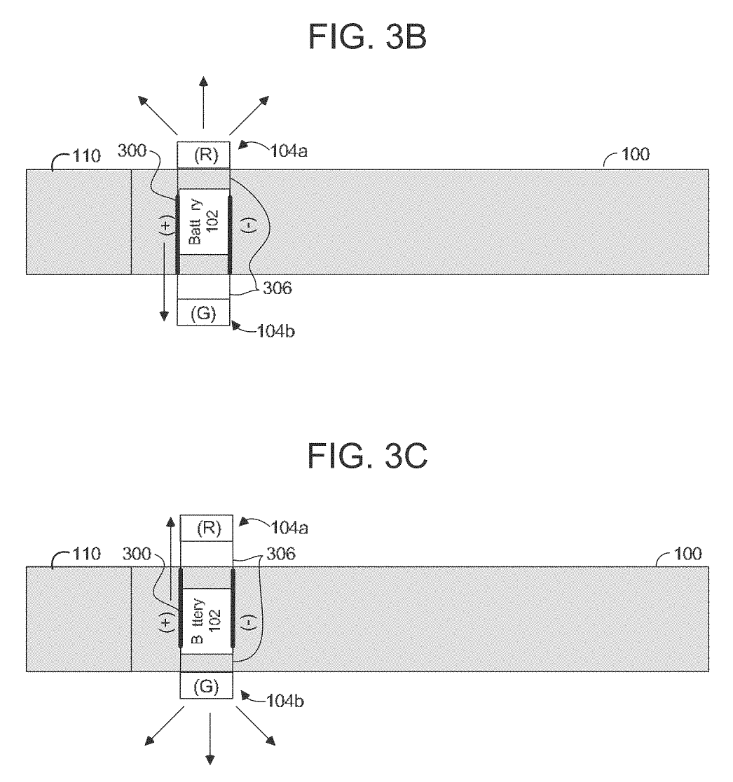

FIG. 3A illustrates a further embodiment of an LED-equipped wristband. FIGS. 3B and 3B illustrate an exemplary procedure/operation for selecting which LED 104a, 104b to illuminate. The LED-equipped wristband of FIG. 3A also includes an adhesive patch 110 for securely fastening the wristband 100. The LED-equipped wristband of FIG. 3A includes a housing, carrier, or shuttle 300 that holds two LEDs 104a, 104b in opposing positions on opposite sides of a battery 102 that is held in a fixed position, such that sliding the housing 300 up and down, or back and forth brings one or the other LED 104a, 104b towards the battery 102. As illustrated in FIG. 3B, when the housing 300 has been slid in a downward direction far enough towards the battery 102, a circuit 306 between the battery 102 and the LED 104a will be closed and the LED 104a will illuminate. Similarly, as illustrated in FIG. 3C, when the housing 300 has been slid in an upward direction far enough towards the battery 102, a circuit 306 between the battery 102 and the LED 104b will be closed and the LED 104b will illuminate. As discussed herein, the circuit 306 illustrated in FIGS. 3A, 3B, and 3C may be made from conductive wiring (e.g., copper or silver wiring) or laid down with conductive ink traces on a surface of the housing 300, such that the housing 300 may be shifted in position to bring the conductive wiring or traces (306) that are coupled to one of the LEDs 104a, 104b into contact with the battery 102 to illuminate the desired LED (104a, 104b).

In an aspect of the present invention, at least a portion of the LEDs 104, 104b, battery 102, conductive wiring or traces (that make up the circuit 306), and the housing 300 are embedded within the wristband 100 with only a fixture on the housing 300 extending through a slit in the wristband 100 that allows the housing 300 to be shifted along from one LED to the other.

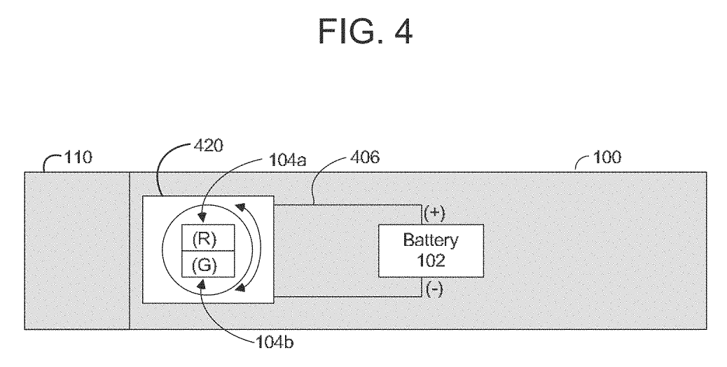

FIG. 4 illustrates an embodiment of an LED-equipped wristband that includes a pair of co-located LEDs 104a, 104b that are electrically coupled to a controller 420 that is wired 406 to a battery 102. The LED-equipped wristband of FIG. 4 also includes an adhesive patch 110 for securely fastening the wristband 100. In one embodiment, the pair of LEDs 104a, 104b are separate LEDs (104a, 104b), while in another embodiment, the LEDs may be implemented as a single, two-color LED unit or module 104. As illustrated in FIG. 4, rotating a portion of the controller 420 causes the controller 420 to energize one or the other of the LEDs 104a, 104b, or selects a particular color for the LED 104. As discussed herein, the circuit 406 illustrated in FIG. 4 that couples the battery 102 to the controller 420 may be made from conductive wiring (e.g., copper or silver wiring) or laid down with conductive ink traces on a surface of the wristband 100, or on another layer within the wristband 100.

In an aspect of the present invention, at least a portion of the controller 420, the battery 102, and conductive wiring or traces (that make up the circuit 406) are embedded within the wristband 100 with the rotating portion of the controller 420 exposed as well as the LEDs 104a, 104b.

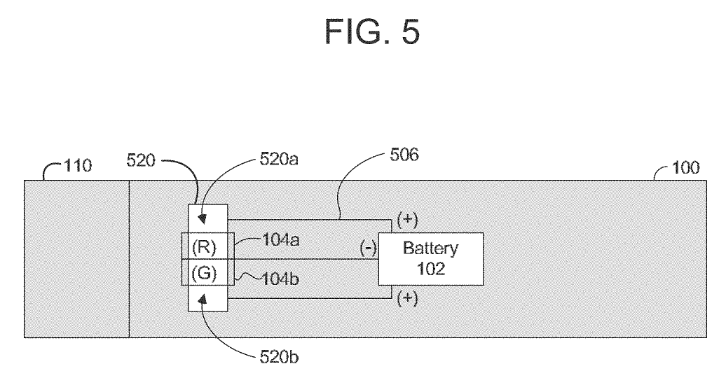

FIG. 5 illustrates an embodiment of an LED-equipped wristband that includes a pair of co-located LEDs 104a, 104b that are electrically coupled to a housing 520 that is physically separated from conductive wires or traces 506 that are communicatively coupled to a battery 102. The LED-equipped wristband of FIG. 5 also includes an adhesive patch 110 for securely fastening the wristband. In one embodiment, the pair of LEDs are separate LEDs (104a, 104b), while in another embodiment, the LEDs may be implemented as a single, two-color LED 104. As illustrated in FIG. 5, pressing on a portion 520a, 520b of the housing 520 will cause that portion 520a, 520b of the housing 520 to electrically couple the battery 102 to one of the LEDs 104a, 104b. For example, pressing on portion 520a will electrically couple the battery 102 to LED 104a, while pressing on portion 520b will electrically couple the battery 102 to LED 104b.

In an aspect of the present invention, the housing 520, the LEDs 104a, 104b, the conductive wires or traces 506, and battery 102 are embedded within the wristband 100. Optionally, only part of the housing 520 is embedded within the wristband 100.

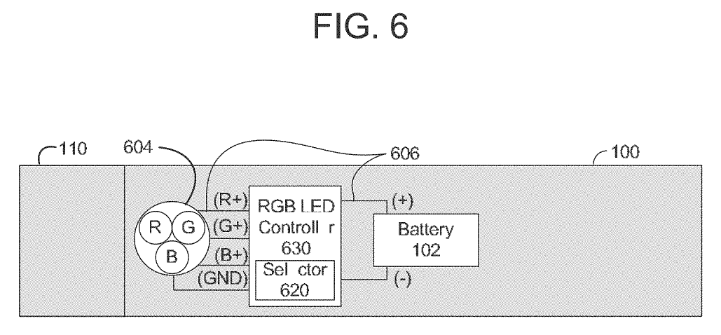

FIG. 6 illustrates an optional RGB LED-equipped wristband that includes an RGB LED 604 that is electrically coupled 606 (via conductive wires or traces) to an RGB LED controller 630 that is in turn electrically coupled 606 to a battery 102. An exemplary RGB LED controller 630 is configured such that a user may select to illuminate at least one color through the use of a selector 620 coupled to the RGB LED controller 630. For example, in illuminating the RGB LED 604, a single press or action on the selector 620 will select one color (e.g., “green”), a second press or action on the selector 620 will select a second color (e.g., “red”), while further presses or actions on the selector 620 will select additional colors, and a final press or action will select “OFF.” Other embodiments and configurations for controlling the selection of one or more colors for illumination are possible. In an aspect of the present invention, the RGB LED 604, the conductive wires or traces 606, the battery, the RGB LED controller 630, and the selector 620 are embedded within the wristband 100. Optionally, only a part of the selector 620 is embedded within the wristband 100.

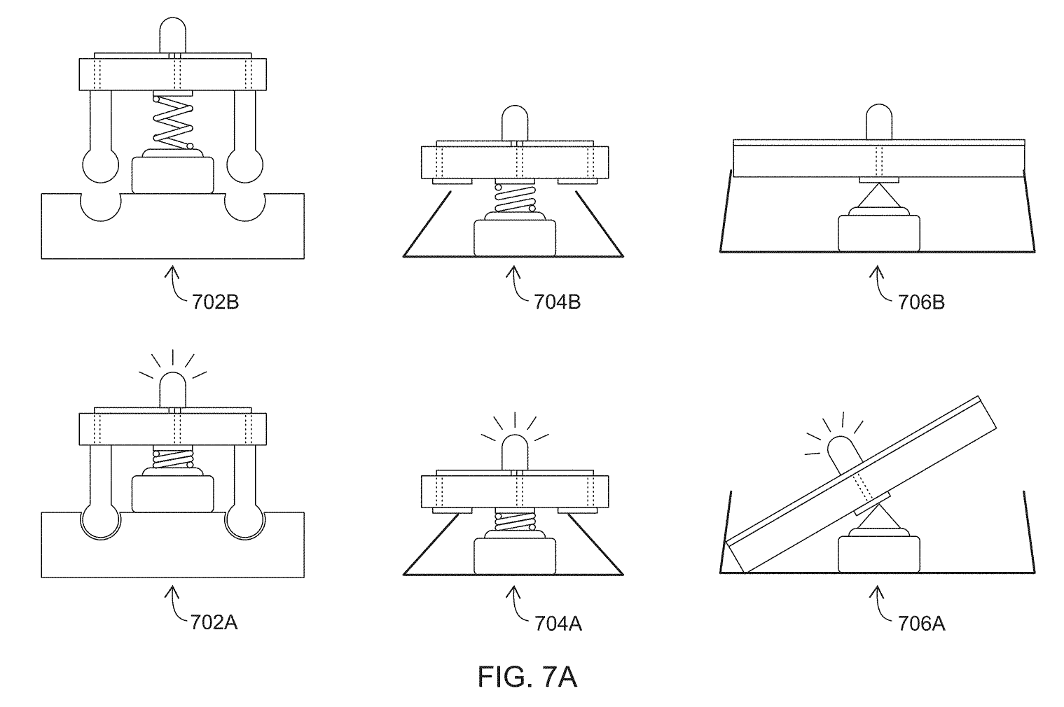

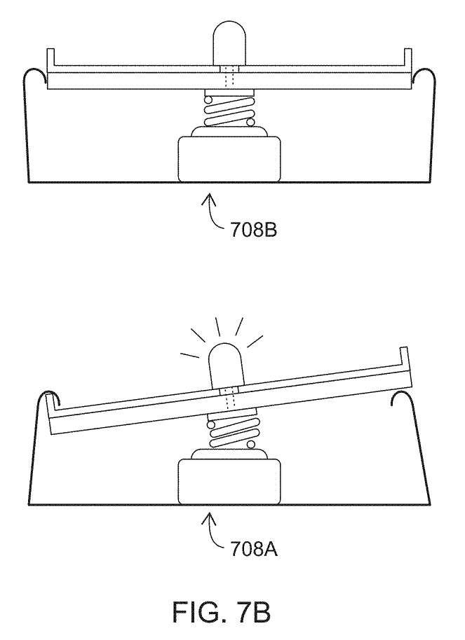

FIGS. 7A and 7B illustrate additional exemplary configurations for switches configured to selectively close a circuit between a battery and one or more LEDs. As illustrated in FIG. 7A, an exemplary spring-mounted circuit portion 702A-B, 704A-B may be engaged with further circuit portions to complete a circuit between the battery and the one or more LEDs. As further illustrated in FIG. 7A, an additional embodiment includes a rocker switch 706A-B with a rocking portion that may selectively close a circuit between a battery and LEDs by engaging a conductive portion of the rocking portion with additional circuit portions below the rocking portion. As illustrated in FIG. 7A, the additional circuit portions positioned below the rocking portion may be formed of conductive ink or copper. The additional embodiment illustrated in FIG. 7B includes a spring-loaded rocker portion with conductive portions that contact additional conductive portions that are arranged below the spring- loaded rocker portion 708A, 708B. As illustrated in FIG. 7B, manipulating the spring-loaded rocker portion brings conductive portions of the spring-loaded rocker portion into contact with those conductive portions below the spring-loaded rocker portion, such that a circuit is closed between a battery and one or more LEDs to energize the one or more LEDs.

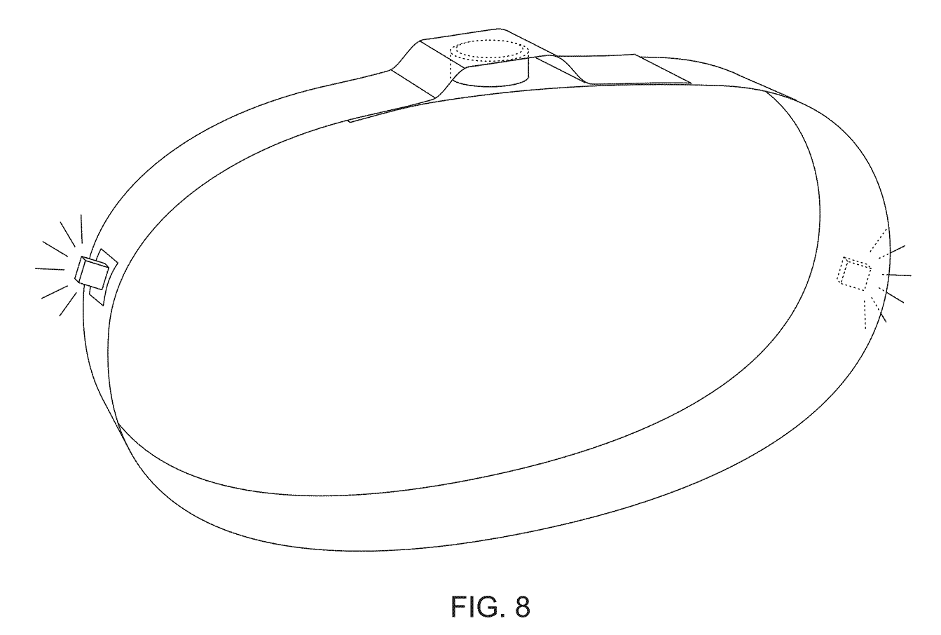

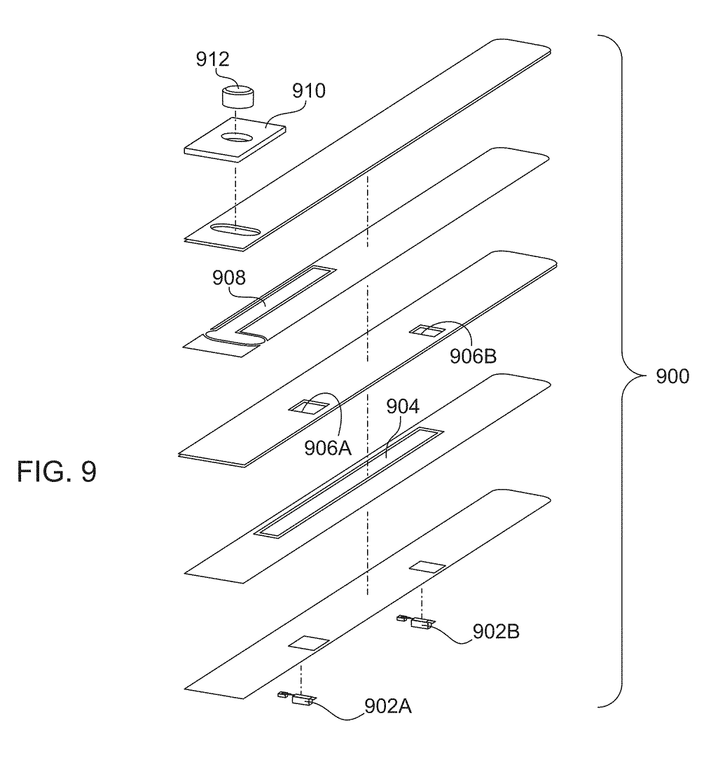

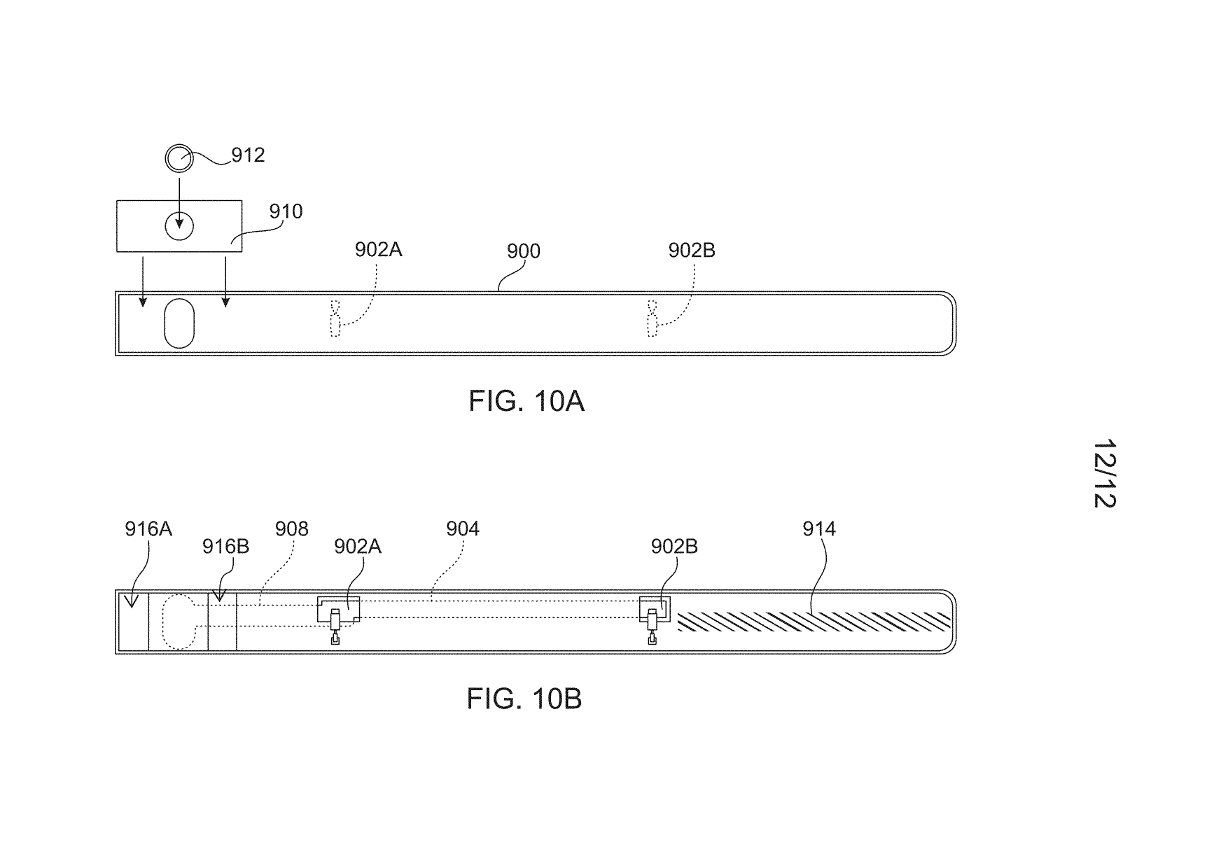

FIG. 8 depicts an additional embodiment of the claimed invention in which opposite ends of an LED-equipped wristband are connected as a wearer (not pictured) would connect them around the wearer's wrist in order to employ the benefits of the invention. Full functionality is displayed as the flexible band is wrapped around the wearer's wrist and the wristband endpoints are connected by means of adhesive connections 916A, 916B. As further described in FIGS. 9, 10A, and 10B, a completed circuit is formed when the positive side of the wristband battery 912 is bonded on its bottom side to an exposed copper portion 914 of the wristband surface and the negative side of the battery is connected on its top side to an exposed copper strip 914 of the overlaying wristband. When the battery 912 is contacted on both sides by copper surfaces, the LEDs 902A, 902B will both light up with voltage regulated by proximate resistors.

FIG. 9 is an exploded view of the embodiment presented in FIG. 8, distinguishing conductive and dielectric layered aspects of a manufactured wristband 900. Specifically, combined LED and resistor units 902A, 902B are connected to one another by means of a trace pattern 904 deposited on a copper layer, with middle layer etchings or carveouts 906A, 906B allowing for the inner and outer copper layers to maintain contact for purposes of completing the circuit. A second trace pattern 908 is deposited on a second copper layer and connected to a battery component 912. Working down the layers, the uppermost layer features a coin cell battery 912. This battery 912 is surrounded by dual sided adhesive tape 910, the tape 910 attaching on its bottom side to a top coverlay of polyimide material. Under the coverlay is a first copper layer 908 forming a means for either a negative or positive connection. Underneath the first copper layer 908 is a middle buffer layer with carveouts 906A, 906B, said middle layer functioning to prevent shorting by contact between first and second copper layers. Underneath the middle layer is a bottom copper layer 904 forming a means for either a negative or positive connection. The bottom most layer is a bottom coverlay of polyimide material. This bottom layer is etched or carved out in a long groove on one end to form a conductive copper strip 914 by exposing the copper layer immediately below the coverlay. Additionally, square form etchings or carveouts allow for the soldering of co-located LEDs and resistors 902A, 902B to the copper layer immediately below the coverlay.

FIG. 10A depicts the rear side of the embodiment previously presented in FIGS. 8 and 9. For avoidance of doubt, this is the inside portion of the wristband 900 when worn by a user, such that it is the side touching the wearer's skin.

FIG. 10B depicts the front side of the embodiment, where newly presented is an exposed copper strip 914 to which a negative connection is made when the strip 914 connects at adhesive points 916A, 916B, overlapping the coin cell battery 912. Also newly presented are dual-sided adhesive layers 916A-B on opposite sides of the battery 912. Cover strips over the adhesive surfaces are removed prior to a connection which when folded around a wearer's wrist connects with a battery 912 that is positioned between adhesive strips 916A, 916B.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

I claim:

1. A light emitting diode (LED)-equipped wristband comprising:
a single-use wristband;
a housing comprising a first LED, a second LED, and a battery for energizing the first and second LEDs, wherein the housing is embedded in the wristband;
wherein the housing comprises first conductive leads configured such that the first LED is energized while a selected first portion of the wristband is pressed such that a first circuit is closed between the first LED and the battery, and wherein the first circuit comprises the first conductive leads; and
wherein the housing further comprises second conductive leads configured such that the second LED is energized while a selected second portion of the wristband is pressed such that a second circuit is closed between the second LED and the battery, and wherein the second circuit comprises the second conductive leads.

2. The wristband of claim 1, wherein the manipulation of the of wristband is accomplished by means of pressing the outer surface of the wristband.

3. A wearable apparatus for signaling information through light displays, comprising:
a flexible wristband with at least one adhesive end portion;
a battery;
at least two light emitting diodes (LEDs) that may selectively be turned on and off; and,
at least one trace connecting a battery to the LEDs.

4. The apparatus of claim 3, further comprising a tactile switch, membrane switch, or push on/off switch for the selective display of LED lights.

5. The apparatus of claim 3, further comprising a slidable battery positioned between two oppositely positioned LEDs, said battery being able to slide from one side of the wristband to the other in order to establish a contact point with a particular LED lights thus energizing said light.

6. The apparatus of claim 3, wherein the wristband end opposite the end featuring an adhesive substance further comprises an exposed copper strip.

7. The apparatus of claim 3, wherein the wristband features a coin cell battery situated proximate to an outward exposed adhesive surface.

8. The apparatus of claim 3, further comprising:
a layered wristband consisting of inner and outer polyimide layers, a first copper conductive layer, and a second copper conductive layer, the copper layers buffered by a neutral middle layer;
a coin cell battery;
two LEDs extending from a coverlay and co-located each with a resistor and soldered to a copper conductive layered just underneath said coverlay; and,
a copper strip exposed to the surface of a coverlay through a coverlay carveout, said strip positioned on the opposite side of the wristband as the battery.

9. A method for signaling an indication with a light emitting diode (LED)-equipped wristband with a housing comprising a first LED, a second LED, and a battery for energizing the first and second LEDs, wherein the housing is embedded in the wristband, the method comprising:
interacting with a selected first portion of the wristband to close a first circuit between the first LED and the battery, wherein energizing the first LED signals a first indication; and
interacting with a selected second portion of the wristband to close a second circuit between the second LED and the battery, wherein energizing the second LED signals a second indication.

10. The method of claim 9, wherein the first LED emits a red light, and wherein the second LED emits a green light.

11. The method of claim 9, wherein a first indication signals a first signal, and wherein a second indication signals a second signal.

12. The method of claim 9, wherein a first indication signals one of “YES,” “AGREE,” and “AVAILABLE.”

13. The method of claim 9, wherein a second indication signals one of “NO,” “DISAGREE,” and “UNAVAILABLE.”

14. The method of claim 9, wherein interacting with a selected portion of the wristband comprises pressing on the selected portion of the wristband.

15. The method of claim 9, wherein interacting with a selected portion of the wristband comprises pressing on a selector switch positioned at the selected portion of the wristband.

16. The method of claim 9, wherein interacting with a selected portion of the wristband comprises rotating a portion of a selector configured to close the first and second circuits.

17. The method of claim 9, wherein the housing further comprises a carrier which retains the first and second LEDs with respect to each other, and retains the battery to a fixed position, and wherein interacting with a selected first portion of the wristband comprises pushing the carrier in a first direction such that the first LED closes the first circuit with the battery, and wherein interacting with a selected second portion of the wristband comprises pushing the carrier in a second direction such that the second LED closes the second circuit with the battery.

18. The method of claim 9, wherein the housing further comprises a carrier which retains the first and second LEDs in fixed positions, and allows the battery to move freely with respect to the first and second LEDs, and wherein interacting with a selected first portion of the wristband comprises pushing the carrier in a first direction such that the battery closes with the first LED, and wherein interacting with a selected second portion of the wristband comprises pushing the carrier in a second direction such that the battery closes the second circuit with the second LED.

19. The method of claim 9, further comprising holding the wristband such that at least one of the first and second LEDs are in line-of-sight of a targeted person.

20. The method of claim 9, wherein holding the wristband such that at least one of the first and second LEDs are in line-of-sight of a targeted person places the first and second LEDs out of line-of-sight of a second targeted person.
